(19) United States
(12) Patent Application Publication
(10) Pub. No.: US 2009/0024984 A1
(43) Pub. Date: Jan. 22, 2009

(54) METHOD OF MANAGING APPLICATION SOFTWARE

(75) Inventor: Kenji Maeda, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/175,345

(22) Filed: Jul. 17, 2008

(30) Foreign Application Priority Data
Jul. 19, 2007 (JP) 2007-188503

(51) Int. Cl. G06F 9/44

(52) U.S. Cl. 717/121; 717/120

(57) ABSTRACT

When there is duplication between already installed applications on the one hand and applications included in integrated package software to be installed on the other hand, usage information that permits a user to use the duplicate application is output. The user is allowed to re-use the duplicate application identical to one of the already installed application, in accordance with the usage information.

### BACKGROUND OF THE INVENTION

1. Field of the Invention

The present invention relates to an information processing apparatus, a method of managing applications, and a computer program, and more particularly, to an information processing apparatus, a method of managing applications, and a computer program, providing a feature that allows integrated package software including a plurality of different applications to be installed in an advantageous manner.

2. Description of the Related Art

License is used to protect purchased application software (hereinafter, referred to simply as an application) from unauthorized use such as unauthorized copying. In general, when an application is installed, a user inputs license information associated with this application. If and only if the input license information is determined to be valid, the installation of the application is allowed. For example, as license information associated with the application, the user inputs identification information (ID) uniquely identifying a device in which the application is to be installed. Specific examples of license information include a host name, an IP address, a device serial number, etc.

As one of techniques to manage license information, Japanese Patent Laid-Open No. 2004-54324 discloses a technique in which when inquiry about a license is received from a user, a screen (a Web page) uniquely personalized to the user is produced and displayed. More specifically, on this screen, a list of applications purchased by the user and licenses therefor is displayed.

Japanese Patent Laid-Open No. 2004-234591 discloses a technique of managing information identifying terminals of authorized users, versions thereof, etc. in an integrated manner. In this technique, a newest version of program or component is transmitted to only terminals of the authorized users without performing authentication, thereby to allow an existing program to be updated.

One method of selling a plurality of applications is to sell them in the form of integrated package software (hereinafter, referred to simply as an integrated package). The integrated package includes, in addition to the plurality of applications having their own functions, an application adapted to integrate the plurality of applications and an installer.

Depending manners in which applications are integrated into an integrated package (depending on combinations of applications), there is a possibility that the same applications are included in two or more different integrated packages. In some cases, depending on price of an integrated package, in addition to selling the integrated package as a whole, a particular application included in the integrated package is sold separately. In this case, the same application is sold as a standalone application and as one of the applications included in the integrated package.

Such a situation creates a possibility that when a user purchases license for an integrated package with the intention of adding new applications to existing applications, the integrated package includes an application identical to one of the existing applications. This can occur if, after license for an application is purchased and the application is installed, an integrated package including this application in addition to other applications is installed, or if a plurality of integrated packages including one or more common applications are installed.

The applications such as those described above are managed using licenses. Therefore, if an integrated package including an application identical to an existing application is installed, licenses for the duplicated applications are wastefully installed in the same system (device). More specifically, when a plurality of licenses are provided individually for applications in an integrated package, licenses for duplicate applications are wasteful. On the other hand, when a single license is provided for an integrated package, waste occurs in duplicate applications.

In the techniques described above, it is not allowed to properly modify licenses for applications depending on the situation. Thus, when an integrated package including an application identical to an existing application is installed, it is difficult to re-use the duplicate application.

### SUMMARY OF THE INVENTION

In view of the above, the present invention provides a technique to re-use duplicate applications when duplication occurs between existing applications and applications included in an integrated package installed newly.

That is, when there is duplication between already installed applications on the one hand and applications included in integrated package software to be installed on the other hand, usage information that permits a user to use the duplicate application is output so that the user is allowed to re-use the duplicate application identical to one of the already installed application, in accordance with the usage information.

According to an aspect of the present invention, there is provided an information processing apparatus comprising a determination unit configured to determine whether at least one of a plurality of applications in integrated package software to be installed by inputting preset usage information is a duplicate application of an already installed application, and an output unit configured to, when the determination unit determines that there is the duplicate application, output the usage information that allows a user to use the duplicate application.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating an example of a license management system according to an embodiment of the present invention.

FIG. 2 is a block diagram illustrating an example of a hardware configuration of a license issuing server according to an embodiment of the present invention.

FIG. 3 is a diagram conceptually illustrating an example of a process of issuing a license file using a license management system according to an embodiment of the present invention.

FIG. 4 is a flow chart illustrating an example of an operation performed by a user system to install applications according to an embodiment of the present invention.

FIG. 5 shows an example of a screen displayed on a user system to prompt a user to input license access number when an application is installed, according to an embodiment of the present invention.

FIG. 6 shows an example of a screen displayed on a user system when a license file is issued, according to an embodiment of the present invention.

FIG. 7 is a diagram illustrating, in a simplified manner, an example of information stored in a license management database, according to an embodiment of the present invention.

FIG. 8 is a diagram illustrating, in a simplified manner, an example of information stored in an integrated product database, according to an embodiment of the present invention.

FIG. 9 is a flow chart illustrating an example of a process performed in a license issuing server to issue a license file, according to an embodiment of the present invention.

FIG. 10 illustrates an example of a format of a license file, according to an embodiment of the present invention.

FIG. 11 is a diagram conceptually illustrating an example of a process of issuing a license file using a license management system according to an embodiment of the present invention.

FIG. 12 is a flow chart illustrating an example of a process performed in a license issuing server to issue a license file, according to an embodiment of the present invention.

### DESCRIPTION OF THE EMBODIMENTS

Embodiments of the present invention will now be described in detail in accordance with the accompanying drawings.

### First Embodiment

A first embodiment of the present invention is described below with reference to drawing. In the following explanation, a browser is a program for browsing contents on a network such as the Internet, and an integrated package is integrated package software that is a combination of a plurality of applications having different functions. In some cases, the integrated package includes an installer in addition to integrated applications having individual functions.

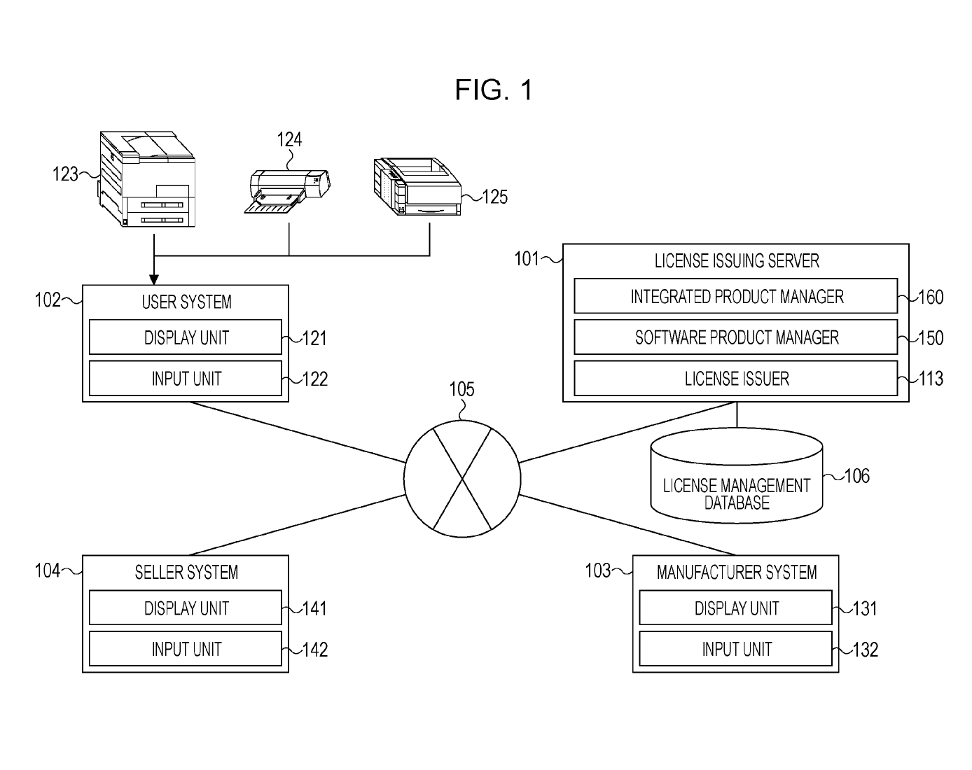

FIG. 1 is a diagram illustrating an example of a configuration of a license management system.

The license management system is adapted to manage optional functions of printing apparatuses 123 to 125, license of electronic devices such as printing apparatuses 123 to 125 and a user system 102, and applications used by electronic devices. The license management system shown in FIG. 1 has the capability of preventing a license of an electronic device or a license of an application used on an electronic device from being used in an unauthorized manner.

In FIG. 1, a license issuing server 101 is an information processing apparatus (a server) adapted to perform general processes associated with issuing of licenses. An information processing apparatus such as a personal computer or a workstation connectable to a network 105 may be used as the license issuing server 101.

A user system 102 is an information processing apparatus (a client apparatus) managed by a user. An information processing apparatus such as a personal computer or a portable terminal device connectable to the network 105 may be used as the user system 102. The printing apparatuses 123 to 125 are connected to the user system 102 via a wired or wireless communication path allowing communication between the printing apparatuses 123 to 125 and the user system 102.

In the present embodiment, the license of an application to be added to the printing apparatuses 123 to 125 or the user system 102 is provided by setting a license file including license information in the printing apparatus 123 to 125 or the user system 102.

The license issuing server 101 is adapted to be capable of managing licenses for various product genres such as “printing apparatuses 123 to 125 and the user system 10” and capable of controlling a function of each apparatus independently of each apparatus. The license issuing server 101 is also capable of issuing a single license for use by a plurality of apparatuses.

The license issuing server 101 includes a software product manager 150, an integrated product manager 160, and a license issuer 113.

The software product manager 150 is adapted to manage license files. The integrated product manager 160 is adapted to manage license of a plurality of apparatuses (for example, at least two of the printing apparatuses 123 to 125) by using a single license file. The license issuer 113 is adapted to issue a license file to an external apparatus.

The functions of the software product manager 150, the integrated product manager 160, and the license issuer 113 are implemented by a CPU disposed in the license issuing server 101 by executing a control program stored in a ROM using a RAM or the like. The software product manager 150, the integrated product manager 160, and the license issuer 113 are capable of communicating with the outside world, for example, via a communication interface disposed in the license issuing server 101.

The manufacturer system 103 is an information processing apparatus possessed by a manufacturer that has produced the printing apparatuses 123 to 125, and the manufacturer system 103 serves to manage the produced printing apparatuses 123 to 125. The seller system 104 is an information processing apparatus possessed by a sales company that has sold the printing apparatuses 123 to 125, and the seller system 104 serves to manage the sold printing apparatuses 123 to 125. An information processing apparatus such as a personal computer or a workstation connectable to the network 105 may be used as the manufacturer system 103 or the seller system 104.

The license management database 106 is a database connected to the license issuing server 101. In the license management database 106, for example, a license access number (LA#), a device serial number (DS#), application information, and a license file are stored.

The network 105 is, for example, the Internet. The user system 102, the manufacturer system 103, and the seller system 104 are connected to the license issuing server 101 via the network 105 so as to achieve a communication capability among them.

In the license issuing server 101 shown in FIG. 1, the software product manager 150 and the integrated product manager 160 have a capability of receiving license information associated with the printing apparatuses 123 to 125 produced or sold from the manufacturer system 103, and registering the received license information.

The license issuer 113 has a capability of issuing a license access number (LA#) in accordance with the registered “license information associated with the printing apparatuses 123 to 125”, and providing it as a license product to the seller system 104 via a market. The seller system 104 produces a certificate including the acquired license access number (LA#). When a seller sells a printing apparatus to a user, the seller attaches the (printed) certificate including the license access number (LA#).

To make it possible for the user, who has purchases the license of the application, to use the application in the user system 102 and the printing apparatuses 123 to 125, a license file issued by the license issuing server 101 is necessary. The license issuing server 101 issues the license file to the user system 102 when the user system 102 properly accesses the license issuing server 101 via the network 105.

In the license file, identification information associated with the printing apparatuses or the user system 102, in which the application is to be installed, is embedded. Only the apparatuses identified by the identification information embedded in the license file are allowed to activate the application corresponding to the license file. That is, to activate this application in another apparatus, a license file for this apparatus is necessary. Thus, unauthorized use of the application is prevented.

In accordance with an operation performed by the user, the user system 102 transfers the license access number (LA#) to the license issuing server 101. In exchange for the license access number (LA#), the license issuing server 101 provides the license file to the user system 102.

After the user acquires the license file, the user inputs the license information by operating a user interface of the user system 102 or an operation panel of the printing apparatus 123 to 125. In response, the application corresponding to the license information is installed in the apparatus (the user system 102 or the printing apparatus 123 to 125) specified by the user, and thus use of the application by the user is enabled.

The user system 102 includes a manufacturer system 103, and the seller system 104 includes input units 122, 132, and 142 adapted to accept an operation and displays 121, 131, and 141 adapted to display an image.

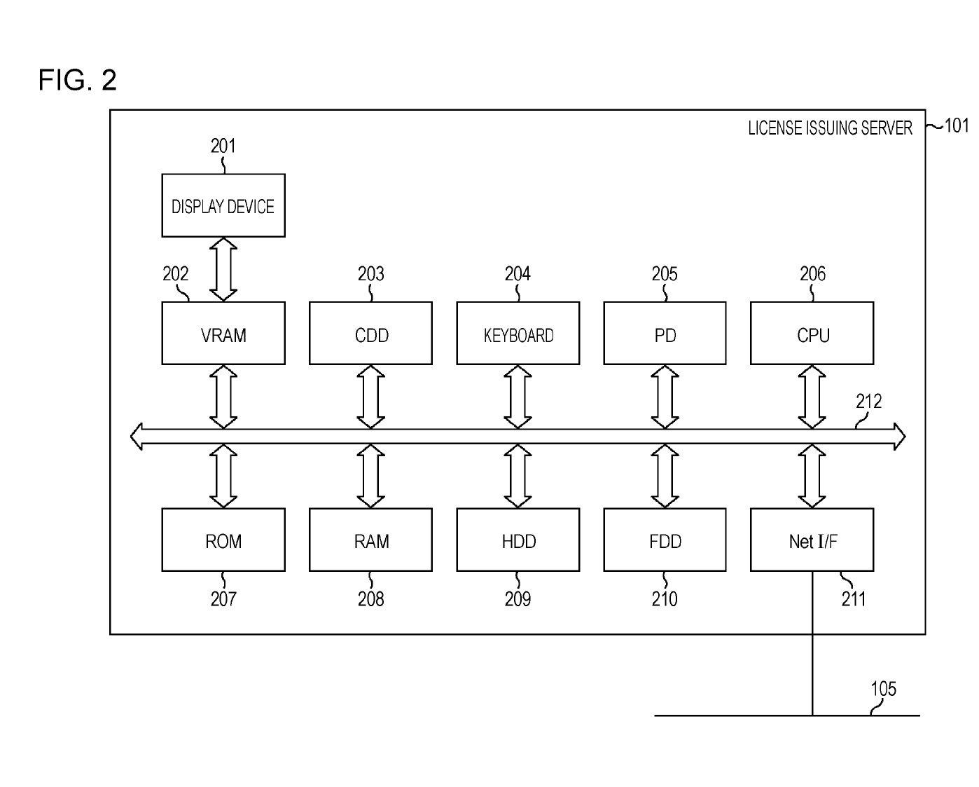

FIG. 2 is a block diagram schematically illustrating an example of a hardware configuration of a license issuing server 101. In FIG. 2, a display 201 is a computer display such as a liquid crystal display. On a display screen of this display 201, user interface information such as a window, an icon, a message, a menu, etc. is displayed. A VRAM (Video Random Access Memory) 202 is used to store image data displayed on the display 201. The image data stored in the VRAM 202 is transferred to the display 201 according to a predetermined scheme. In accordance with the transferred image data, the display 201 displays an image thereon.

A CDD (Compact Disk Drive) 203 is a device adapted to read/write various kinds of control programs or data from/to a storage medium such as a CD-ROM disk or a CD-R disk. Instead of the CDD 203, a DVD drive may be used.

A keyboard 204 includes various kinds of keys operated by a user to input characters or the like. A PD (Pointing Device) 205 is used by a user, for example, to point to an icon, a menu, or other objects displayed on the display screen of the display 201.

A CPU (Central Processing Unit) 206 reads a control program from the CDD 203, a ROM (Read Only Memory) 207, an HDD (Hard Disk Drive) 209, or an FDD (Flexible Disk Drive) 210. The CPU 206 executes the read control program using a RAM (Random Access Memory) 208 to control various devices connected to the CPU 206. In the ROM 207, various kinds of control programs and data are retained. The RAM 208 includes a work area for use by the CPU 206, a save area in which data is saved in an error handling process, and an area in which the control program is loaded. The HDD 209 is an auxiliary storage device for storing various kinds of control programs and data.

A network interface (Net I/F) 211 is a communication interface for communicating, via the network 105, an information processing apparatus such as the printing apparatuses 123 to 125, the user system 102, the manufacturer system 103, or the seller system 104. A CPU bus 212 includes and address but, a data bus, and a control bus.

The control program executed by the CPU 206 may be provided from the ROM 207, the HDD 209, the FDD 210, or the CDD 203, or from another information processing apparatus via the network 105.

The basis hardware configuration of the license issuing server 101 has been described above with reference to FIG. 2. Note that the hardware of the user system 102, the manufacturer system 103, and the seller system 104 may also be configured in a similar manner to that shown in FIG. 2.

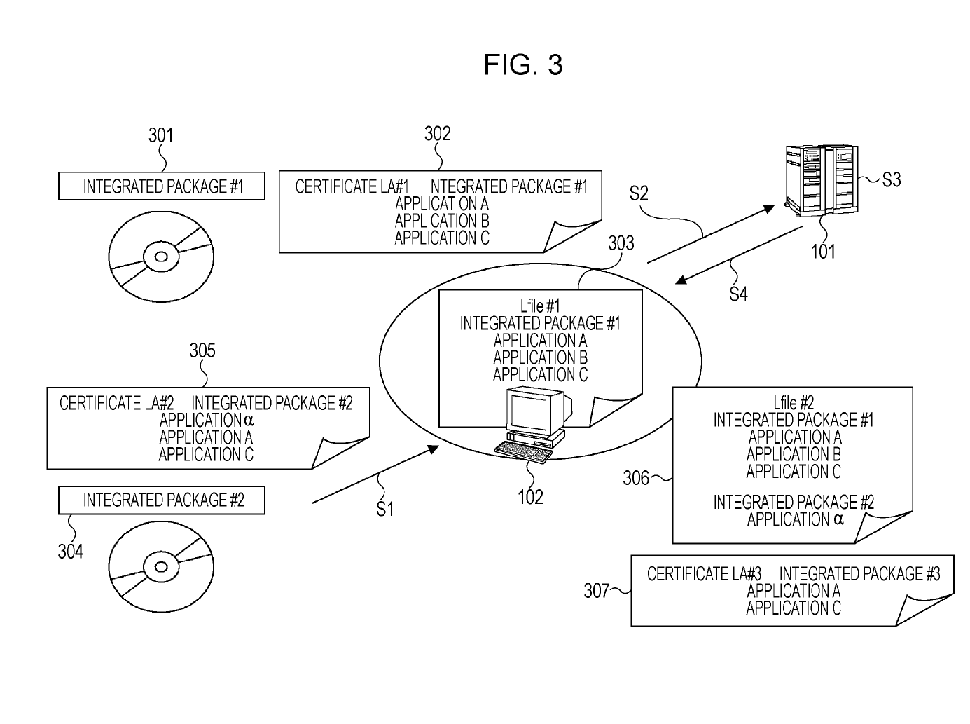

FIG. 3 is a diagram conceptually illustrating an example of a process of issuing a license file using the license management system. In the user system 102 possessed by a user, an integrated package 301 and a license file (Lfie#1) 303 for the integrated package 301 are installed.

The installation thereof is performed using a license access number LA#1 described in a certificate (electronic certificate) 302 of the integrated package 301. In the integrated package 301 purchased by the user, three applications A, B, and C are packaged. By installing the integrated package 301 in the user system 102, it becomes possible for the user to use functions of the applications A, B, and C.

In the above-described situation, if the user performs an operation to install a new integrated package 304 including applications α, A, and C into the user system 102, using a license access number LA#2 described in a certificate 305 of the integrated package 304, then a process including steps S1 to S4 is performed as described below.

In step S1, if the integrated package 304 is loaded into the user system 102, the user system 102 requests a user to input a license access number LA#. The user inputs a license access number LA#2 described in the certificate 305 of the integrated package 304 by using the keyboard 204 of the user system 102.

In step S2, the installer of the integrated package 304 notifies the license issuing server 101 of the license access number LA#2 input in step S1 and a device serial number DS uniquely assigned to the user system 102. That is, the user system 102 requests the license issuing server 101 to provide a new license file 306.

In step S3, the license issuing server 101 receives the license access number LA#2 and the device serial number DS uniquely assigned to the user system 102 from the user system 102. The license issuing server 101 then searches for an already issued license file from registration information registered in a database by using the received device serial number DS as a search key.

Furthermore, the license issuing server 101 searches for applications included in the integrated package 304 to be installed, from the registration information registered in the database, by using the received license access number LA#2 as a search key. Subsequently, on the basis of the already issued license file and the applications in the integrated package 304 which have been found in the search, the license issuing server 101 determines whether any application already installed in the user system 102 is identical to any application included in the integrated package 304. That is, the license issuing server 101 there is duplication between already installed applications and the applications included in the integrated package 304.

Depending on the state in terms of the duplication of applications, the license issuing server 101 produces a certificate (electronic certificate) 307 including a new license file (Lfile #2) 306 and a new license access number LA#3. The new license file (Lfile #2) 306 includes license information that permits the operation of the integrated package 301 (applications A, B, and C) and the integrated package 304 (application α). In the present embodiment, this license file (Lfile #2) 306 overwritten on the license file (Lfile #1) 303 already installed in the user system 102.

In step S4, the user system 102 receives the certificate 307 including the license file (Lfile #2) 306 and the license access number LA #3. The user system 102 performs the installation according to the license file (Lfile #2) 306 such that, of applications α, A, and C included in the integrated package 304 to be additionally installed, only the application α having no duplication with any existing application. Thereafter, the user system 102 issues the certificate 307 including the license access number LA#3 thereby to notify the user that, of the applications α, A, and C included in the integrated package 304, the applications A and C, which are identical (duplicate) to applications which have already been installed, are allowed to be newly installed in another user system.

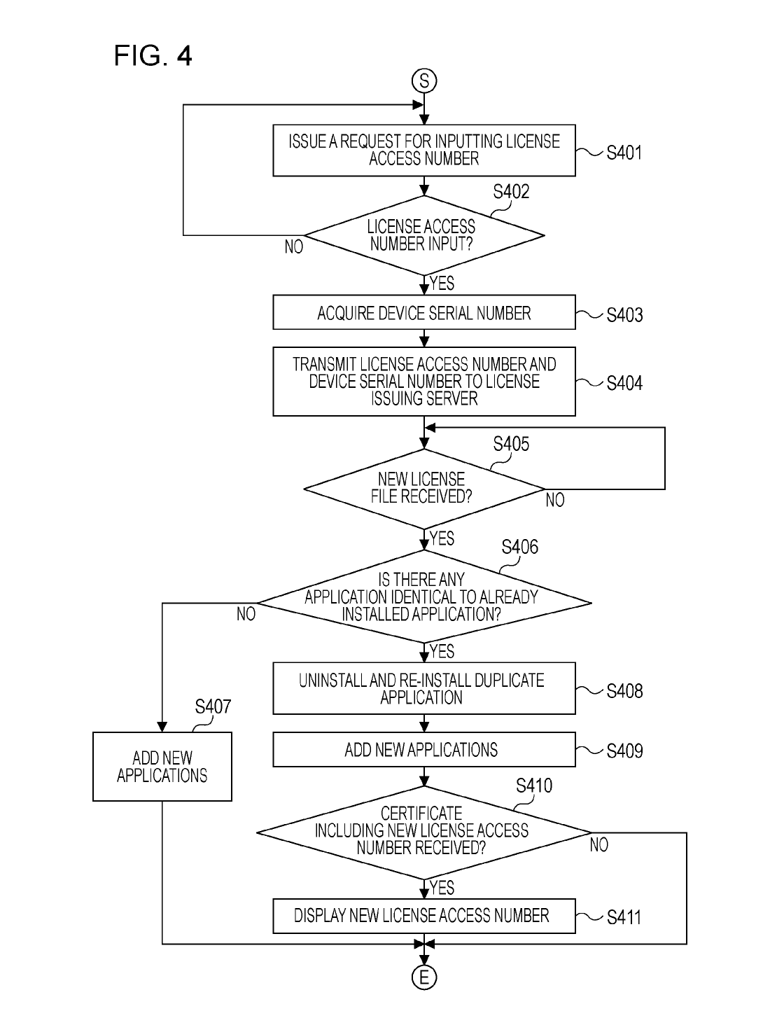

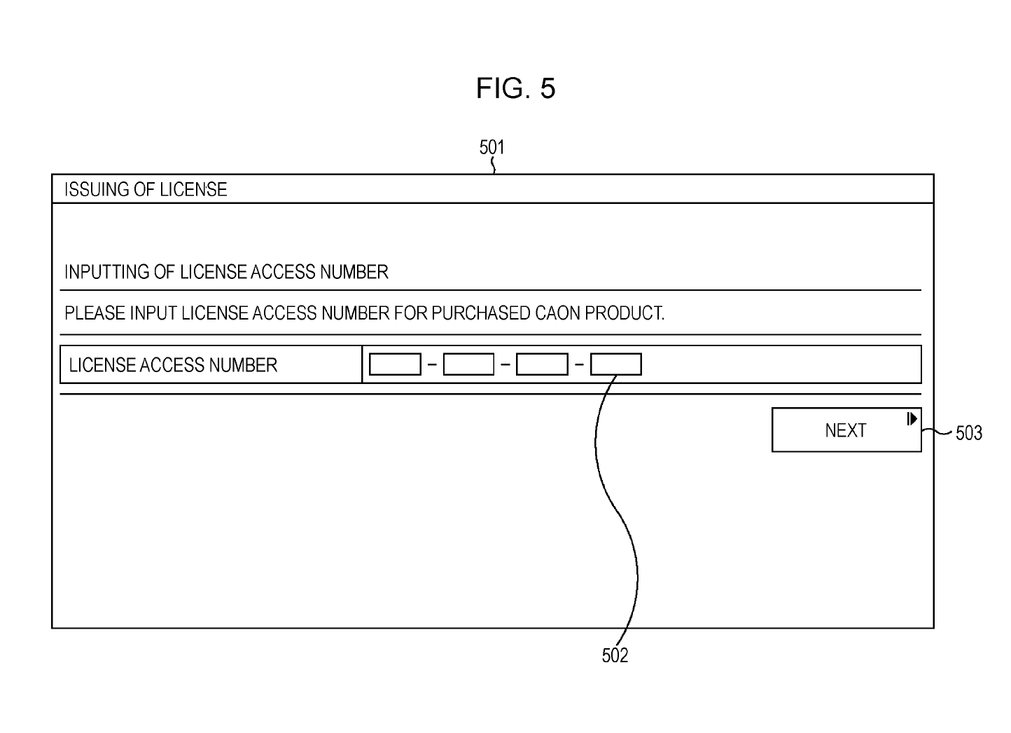

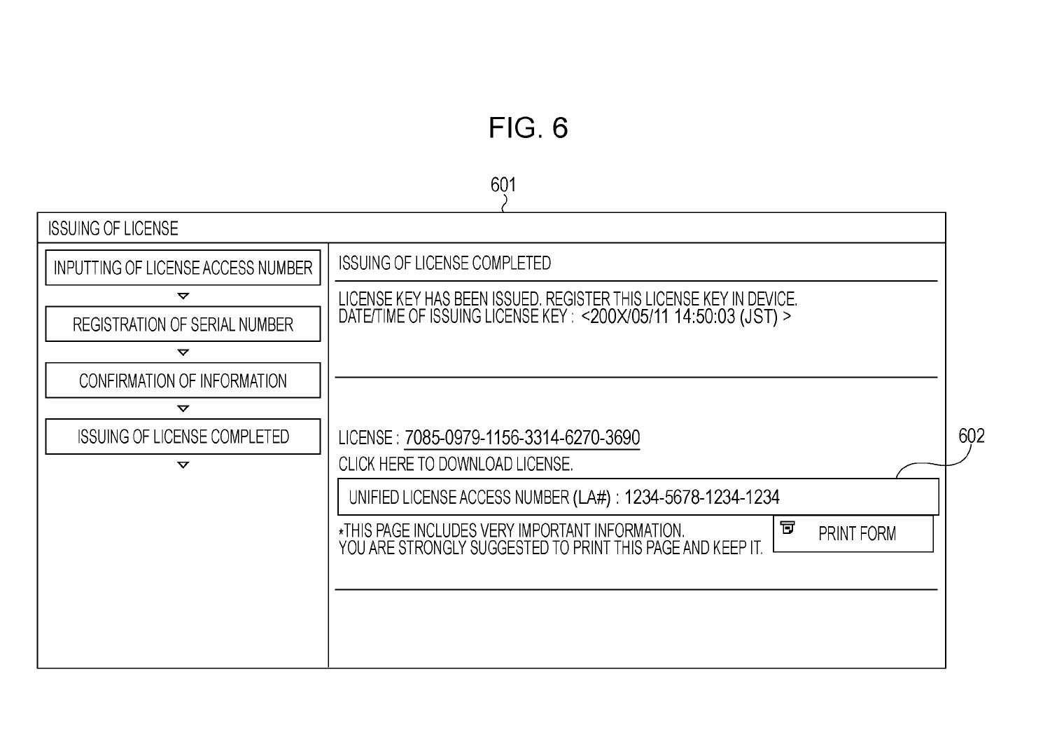

FIG. 4 is a flow chart illustrating an example of an operation performed by the user system 102 to install an application. FIG. 5 illustrates an example of a screen displayed on the display 201 (display 121) of the user system 102 to prompt a user to input a license access number LA# when an application is installed. FIG. 6 illustrates an example of a screen that is displayed on the display 201 (display 121) of the user system 102 when a license file is issued.

Referring to FIGS. 4 to 6, an example of the operation performed by the user system 102 to install an application is described below. The process shown in the flow chart of FIG. 4 is accomplished by the CPU 206 of the user system 102 by executing a control program. First, when the integrated package 304 is loaded into the user system 102, an installer of the integrated package 304 starts to operate in the user system 102, and the user system 102 requests a user to input a license access number LA# (step S401). The user system 102 waits in step S402 until the license access number LA# is input.

In the above process, the user system 102 displays the input screen 501 shown in FIG. 5 to prompt the user to input the license access number (LA#). The user inputs the license access number LA#2 described in the certificate 305 of the integrated package 304 in a license access number input boxes 502, and presses a button 503 to proceed to a next operation.

If the license access number LA# is input in the above-described manner, then the installer of the integrated package 304 acquires a device serial number DS# assigned to the user system 102 (step S403).

In accordance with the operation of the installer of the integrated package 304, the user system 102 transmits the input license access number LA# and the acquired device serial number DS# to the license issuing server 101 (step S404), and the user system 102 requests the license issuing server 101 to provide a new license file 306.

The user system 102 waits until the new license file 306 is received from the license issuing server 101. In a case where any application included in the integrated package 304 loaded in the user system 102 is identical to any application that has already been installed, a certificate 307 including a license access number LA#3 is also received together with the license file 306.

If the license file 306 (and the certificate 307 including the license access number LA#3) is received (step S405), the process proceeds to step S406. In this case, the installer of the integrated package 304 (on the user system 102) determines whether any application in the integrated package 304 is identical to any already installed application (step S406). This determination is made, for example, on the basis of a result of comparison between the content of the license file 306 received from the license issuing server 101 and the content of the already installed license file 303.

The result of the determination indicates that any application in the integrated package 304 is not identical to any already installed application, the process proceeds to step S407. In this case, the installer of the integrated package 304 installs applications to be added (i.e., applications which are not identical to any application which has already been installed) (step S407). The installer of the integrated package 304 then stores the received license file 306. If the license file 306 is stored, the flow chart shown in FIG. 4 is completed. Note that in the above process, the existing license file 303 is replaced with the new license file 306.

On the other hand, in a case where it is determined that the integrated package 304 includes an application identical to some application which has already been installed, the process proceeds to step S408. In this case, the installer of the integrated package 304 uninstalls the existing application corresponding to the identical application in the integrated package 304, and installs the identical application in the integrated package 304 (step S408).

Thereafter, the installer of the integrated package 304 installs applications to be added, i.e., applications which are not identical to any already installed application (step S409). The installer of the integrated package 304 then stores the received license file 306. Note that in the above process, the existing license file 303 is replaced with the new license file 306.

Thereafter, the user system 102 determines whether the certificate 307 including the new license access number LA#3 has received from the license issuing server 101 (step S410). If it is determined that the certificate 307 including the new license access number LA#3 has already been received, the process proceeds to step S411, and the user system 102 detects the format of the license access number LA#3 (the number of digits or the format of a character string) and displays the license access number LA#3 in a unified license access number display box 602 of the display screen 601 shown in FIG. 6 (step S411).

The displaying of the display screen 601 allows the user to know that the new license access number LA#3 has been issued. Thus, in the example shown in FIG. 3, the user is allowed to re-use applications A and C.

In the flow chart shown in FIG. 4, the installer of the integrated package 304 automatically stores and sets the license file 306 in the user system 102. However, this is not necessarily needed. For example, the installer of the integrated package 304 may store the license file 306 in accordance with a command issued by a user. Alternatively, the user system 102 may store the license file 306 without using the installer of the integrated package 304. In the case where the installer of the integrated package 304 is used, the installer does not necessarily need to directly communicate with the user system 102.

In the flow chart shown in FIG. 4, the device serial number DS# is automatically acquired by the installer of the integrated package 304. Alternatively, the device serial number DS# may be manually acquired. As for the device serial number DS#, a number in a predetermined form, an ID of the CPU 206 of the user system 102, a number of an IDE controller, a MAC address of a network board, or the like may be used.

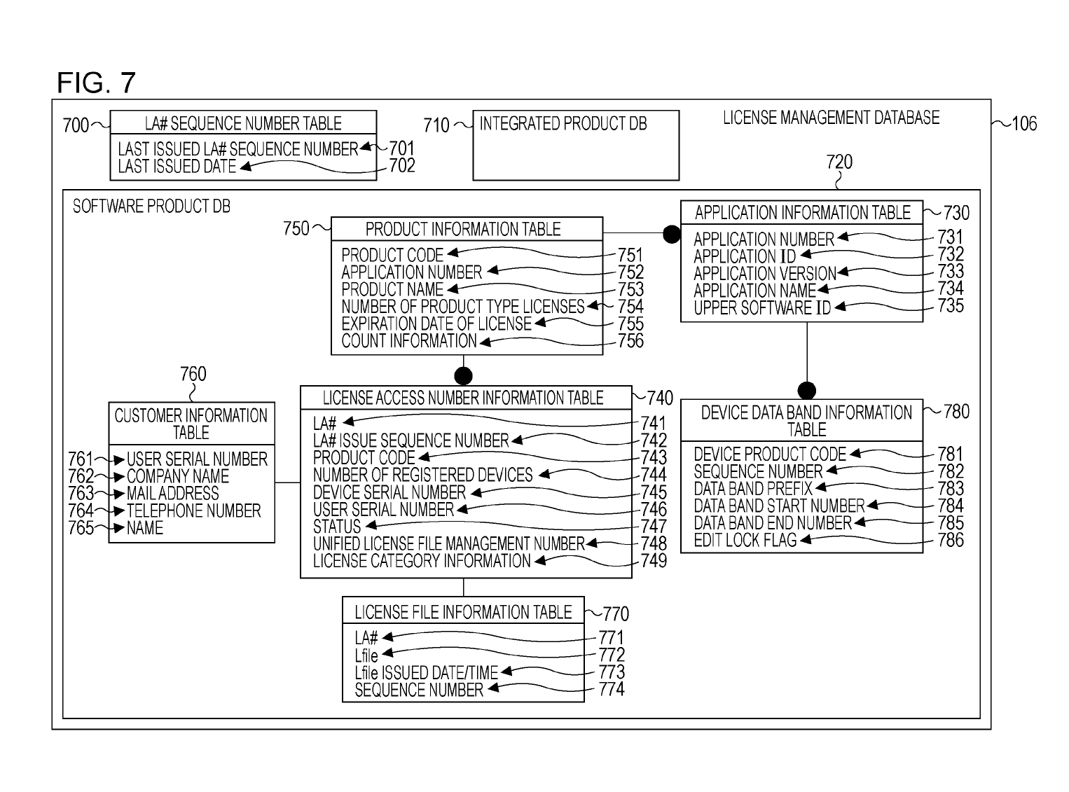

FIG. 7 briefly shows an example of information stored in the license management database 106.

The license management database 106 includes an LA# sequence number table 700, an integrated product database (DB) 710, and a software product database (DB) 720.

The LA# sequence number table 700 describes sequence numbers by which to manage license access numbers issued, by the license issuing server 101, in common to products (applications or integrated packages). Each time a license access number is issued, a sequence number uniquely assigned to the issued license access number is stored in the LA# sequence number table 700. More specifically, a last LA# sequence number 701 indicating a last issued sequence number and a last issued date 702 of the sequence number are stored in the LA# sequence number table 700.

The software product database 720 is for managing individual applications. The software product database 720 includes an application information table 730 and a license access number information table 740. The software product database 720 also includes a product information table 750 that relates the application information table 730 to the license access number information table 740. A product information table includes product code 751, application number 752, product name 753, number of product type licenses 754, expiration date of license 755 and count information 756. Furthermore, the software product database 720 also includes a customer information table 760, a license file information table 770, and a device number data band information table 780.

There is an one-to-many correspondence between the product information and the license access number, that is, there can be a plurality of license access numbers corresponding to one piece of product information.

To make it possible to allow a plurality of devices (the user system 102, printing apparatuses 123 to 125, etc.) to manage the license file, the number of registered devices 744 is recorded to manage the number of devices in which the license file has been registered. Note that the number of devices managed by the number of registered devices 744 indicates the number of devices that are given the same license access number that allows the devices to use the same application.

In the license file information table 770 describes a license access number (LA#) 771, a license file (Lfile) 772, a date/time of issuing the license file 773, and a sequence number 774 indicating the number of times the license file has been updated. Use of the sequence number 774 allows the license access number (LA#) to be manages such that the license access number (LA#) are allowed to be used by a plurality of different devices.

The application information table 730 describes an application number 731 indicating a product, and an application ID 732 that is a management number by which to specify an application used in the printing apparatuses 123 to 125. The application information table 730 also describes an application version 733 indicating a version of an application, an application name 734, and an upper software ID 735. An application such as an installer for installing applications of an integrated package in a user environment is also managed by this application information table 730.

In a case where an upper software ID 832 described later is set as the upper software ID 735, the application identified by the application ID 732 can be part of a set of applications included in the integrated package.

The license access number information table 740 describes a license access number (LA#) 741, a license access number issue sequence number 742, and a product code 743. The license access number information table 740 also describes the number of registered devices 744, a device serial number (DS#) 745, a user serial number 746, a status 747, a unified license file management number 748, and license category information 749.

The status 747 indicates the status (valid or invalid) of the license file. The status 747 also indicates whether a license file has been divided or a plurality of license files have been unified and thus an increase has occurred in the number of products under management. The license category information 749 is basic information according to which the license file of the integrated package is issued. More specifically, the license category information 749 includes a code predetermined depending on whether the license is for an application singly sold or for an integrated package including a plurality of applications. According to this code, the license issuing server 101 determines whether to permit provision of the license file for the integrated package.

The unified license file management number 748 indicates a management number of an integrated package subjected to rearrangement in terms of a license file when an application is bound to a license file of the integrated package (when the application is brought under the management of another integrated package).

The customer information table 760 describes a user serial number 761, a company name 762, a mail address 763, a telephone number 764, and a name 765.

There is a one-to-many correspondence between the device number data band information table 780 and the product information table 750, i.e., there can be a plurality of device number data bands corresponding to one product. The device number data band information table 780 describes a device product code 781, a sequence number 782, a device band prefix 783, a data band start number 784, a data band end number 785, and an edit lock flag 786.

If a process such as changing of registration of a product of issuing an license access number in the seller system 104 or the manufacturer system 103, a record is produced in the software product database 720 or changed in accordance with a result of the process. The registration/change of the content of the software product database 720 is performed by using an UI (User Interface) disposed in the license issuing server 101.

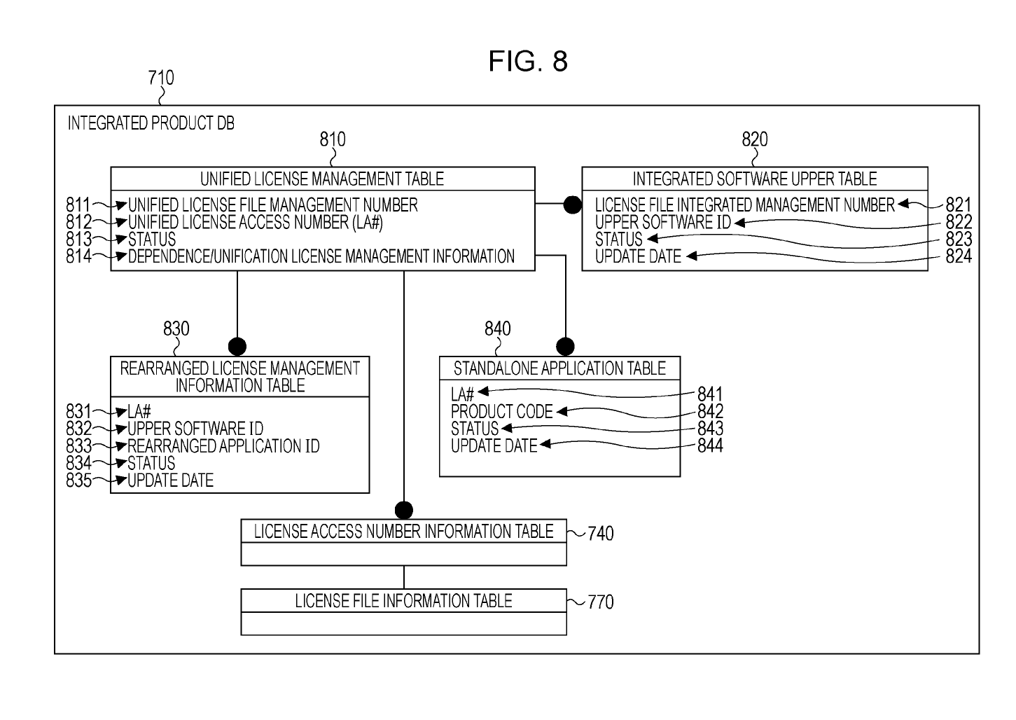

FIG. 8 briefly shows an example of information stored in the integrated product database 710. The integrated product database 710 is used to manage individual applications in an integrated manner. In FIG. 8, similar tables or fields to those in FIG. 7 are denoted by similar reference numerals, and a further detailed description thereof is omitted.

The integrated product database 710 includes a unified license management information table 810 for managing duplication among integrated packages, and an integrated software upper table 820 describing an application (including an installer) that manage, in a unified manner, a group of applications. The integrated product database 710 further includes a license access number information table 740, a license file information table 770, and a rearranged license management information table 830 used to manage a principal-derivative relationship in rearrangement of an integrated package. Furthermore, the integrated product database 710 also includes a table mainly related to a standalone application table 840 indicating applications included in each integrated package.

The unified license management information table 810 by which to manage the duplication among integrated packages includes a unified license file management number 811, a unified license access number (LA#) 812, a status 813, and a dependence/unification license management information 814.

The unified license file management number 811 indicates a unique number indicating a state of an integrated package managed in the integrated product database 710. The unified license access number (LA#) 812 is used to manage a unique sequence number managed by the LA# sequence number table 700 as a sequence number associated with a license file of an integrated package.

The status 813 indicates one of states (a) to (c) described below. State (a) is a state in which no change occurs in the state of an existing license file (any application in an integrated package to be additionally installed is identical to any already installed application). State (b) is a state in which an old license file is replaced with a new license file so that the new license file can be used for an integrated package newly installed (i.e., an old application identical to an application included in the new integrated package is first uninstalled, and then the application in the new integrated package is installed). State (c) is a state in which a license access number has been issued thereby to make it possible to re-use a duplicate application.

The dependence/unification license management information 814 is for managing the relationship among sets of applications in integrated packages, and more specifically, the dependence/unification license management information 814 is used to indicate that rearrangement of applications in integrated packages has been made. For example, the dependence/unification license management information has a value of “0” when installation of an integrated package has led to rearrangement of applications included in another integrated package, and a value of “1” when rearrangement of applications in the present integrated package has occurred as a result of installation of another integrated package.

The integrated software upper table 820 manages an application (including an installer) that integrally manages a group of applications. The integrated software upper table 820 describes a unified license file management number 821, an upper software ID 822, a status 823, and an update date 824. The upper software ID 822 is assigned an application number 731 indicating a product. The upper software ID 822 is bound to an integrated package.

The license access number information table 740 manages a license access number newly issued when a license file of an integrated package is issued, and the license file information table 770 manages the issued license file.

The rearranged license management information table 830 describes a license access number (LA#) 831, an upper software ID 832, a rearranged application ID 833, a status (valid or invalid) 834, and an update date 835. The rearranged license management information table 830 is a table by which to manage a license file of an integrated package subjected to rearrangement performed on detecting duplication between an integrated package to be additionally installed and another integrated package.

The license access number (LA#) 831 is assigned a license access number of an application subjected to rearrangement. The upper software ID 832 is assigned to an ID of upper software subjected to rearrangement. The rearranged application ID 833 is assigned an ID of an application brought under management of the unified license management information table 810 as a result of rearrangement.

The standalone application table 840 describes a license access number (LA#) 841, a product code 842, a status 843, and an update date 844. The standalone application table 840 is used to manage applications included in an integrated package. That is, the standalone application table 840 is used to manage a license file of an application subjected to rearrangement performed when an integrated package to be additionally installed is detected to include an application identical to another standalone application (product). When rearrangement occurs, original information bound to the application is stored in the standalone application table 840.

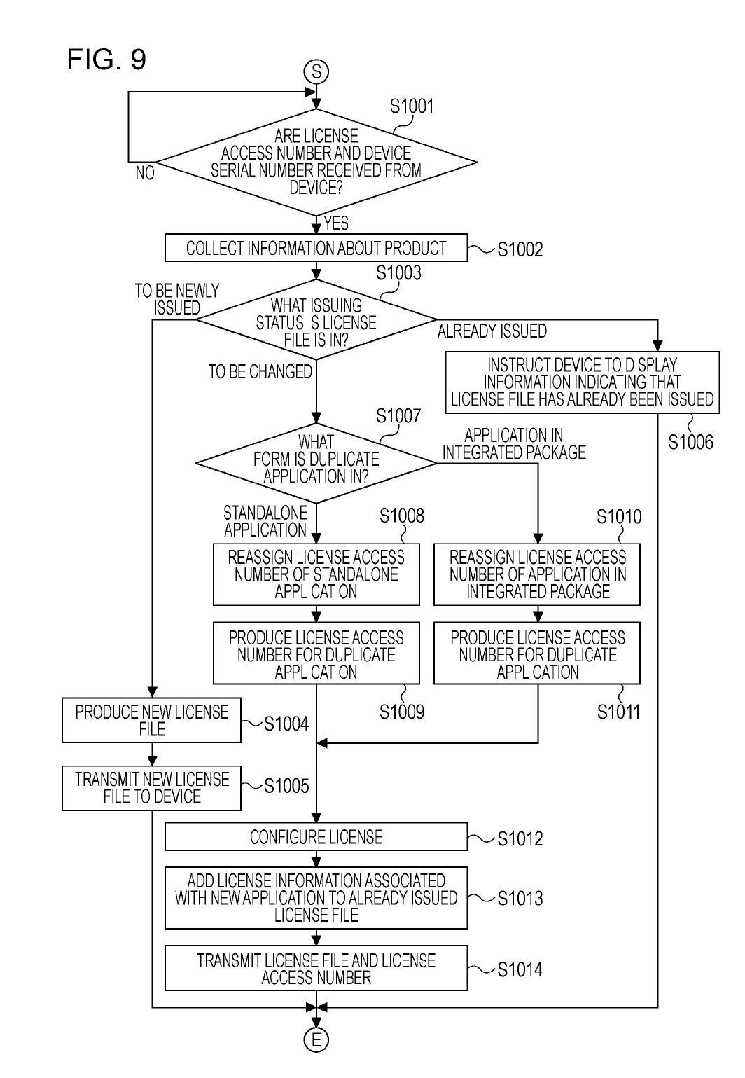

FIG. 9 is a flow chart illustrating an example of a process performed in the license issuing server 101 when a license file is issued. The process shown in this flow chart of FIG. 9 is performed, for example, by the CPU 206 disposed in the license issuing server 101 by executing a control program.

The license issuing server 101 waits until a license access number LA# and a device serial number DS# are received as a license file acquisition request from a device (for example, the user system 102) (step S1001).

In the present embodiment, for example, license issue request information is represented by the license access number LA# and the device serial number DS#. More specifically, certificate information is given by the license access number LA# and identification information is given by the device serial number DS#. In the present embodiment, by executing the process in step S1001 in the above-described manner, a receiving unit is realized.

If a license access number LA# and a device serial number DS# are received, the license issuing server 101 searches the integrated product database 710 and the software product database 720 by using the received license access number LA# and the device serial number DS# as search keys (step S1002). In this search process, “information about products (applications) for which a license file has been issued” which is bound to the device serial number DS and “information about products (applications) or an integrated package” bound to the license access number LA# are collected (identified).

In the present embodiment, by executing the process in step S1002 in the above-described manner, a first identifying unit and a second identifying unit are realized.

Next, on the basis of the information collected (determined) in step S1002, the license issuing server 101 determines what status# the license file is in (step S1003). If a result of the determination indicates that a new license file is to be issued, the processing flow proceeds to step S1004. In a case where the result of the determination indicates that acquisition of an already issued license file is requested, and thus it is not necessary to issue a license file, the processing flow proceeds to step S1006. In a case where an integrated package to be additionally installed includes an application identical to an application which has already installed in a device, and thus it is necessary to change the status (the configuration) of an existing license file, the processing flow proceeds to step S1007.

In the present embodiment, by executing the process in step S1003 in the above-described manner, a determination unit is realized.

In step S1004, the license issuing server 101 produces a new license file according to the license file acquisition request. The license issuing server 101 transmits the license file produced in step S1004 to the device from which the license file acquisition request was received. Thereafter, the process of the flow chart shown in FIG. 9 is ended (step S1005).

In the case where the processing flow proceeds to step S1006, the license issuing server 101 transmits information indicating that the requested license file has already been issued to the device from which the license file acquisition request was received.

In the case where the processing flow proceeds to step S1007, the license issuing server 101 determines whether the duplicate application identical to the application which has already been installed in the device is a standalone application or one of applications in an integrated package. If a result of the determination indicates that the duplicate application identical to the application which has already been installed in the device is an application in an integrated package, the processing flow proceeds to step S1010 which will be described later.

On the other hand, if the duplicate application identical to the application which has already been installed in the device is a standalone application, the processing flow proceeds to step S1008. In this case, the license issuing server 101 re-configures the license access number for the standalone application (step S1008). In the present embodiment, the license issuing server 101 changes the binding of the license access number information table 740 according to the license access number LA# bound to the device serial number DS# and the application ID. More specifically, the license issuing server 101 changes the number pointing to the license file of the integrated package bound to the received license access number LA# to the unified license file management number 748. Furthermore, the license issuing server 101 registers information associated with the duplicate application in the standalone application table 840, and updates the license access number information table 740.

Next, the license issuing server 101 produces a license access number (LA#) for the duplicate application identical to the application already installed in the device (step S1009). The license issuing server 101 then produces a new license access number information table 740. Thereafter, the processing flow proceeds to step S1012.

In a case where it is determined in step S1007 that the duplicate application identical to the application already installed in the device is an application in an integrated package, the process proceeds to step S1010. In this case, the license issuing server 101 re-configures the license access number for this application in the integrated package (step S1010). More specifically, according to the license access number LA# bound to the device serial number DS# and the application ID, the license issuing server 101 registers information associated with the integrated package, whose binding is to be changed, in the rearranged license management information table 830.

Subsequently, of applications included in the integrated package, for the duplicate application identical to the application already installed in the device, the license issuing server 101 produces a license access number (LA#) (step S1011). The license issuing server 101 then produces a new license access number information table 740. Thereafter, the process proceeds to step S1012.

In step S1012, the license issuing server 101 builds license information. In the present embodiment, the license issuing server 101 fixes the binding between license access numbers LA# and the information associated with the applications to be newly added. More specifically, the license issuing server 101 fixes the binding of the “device serial number DS# and the customer information” to the license access number information table 740.

Subsequently, the license issuing server 101 adds license information associated with the new applications to the license file that has already been issued (step S1013). The license issuing server 101 relates the new applications to the following databases. That is, the license issuing server 101 relates the new applications to a license access number LA# or device serial number DS# described in the license file information table 770, the license access number information table 740, unified license management information table 810, etc., in the integrated product database 710.

In the present embodiment, by executing the process in steps S1008 to S1013 in the above-described manner, a reconfiguration unit is realized.

The license issuing server 101 then sends a certificate including the new license access number LA# instead of the existing license access number LA# and the license file to the device from which the license file acquisition request was received. Thereafter, the process of the flow chart shown in FIG. 9 is ended (step S1014). The certificate including the new license access number LA# may be a certificate issued for an integrated package or for one or more applications.

In the present embodiment, as described above, the usage information that allows a user to use duplicate applications is realized by the certificate including the new license access number LA# (for example, the certificate 307 including the new license access number LA#3 (FIG. 3)). Furthermore, in the present embodiment, the license information is realized by the license file (for example, the license file (Lfile #2) 306 shown in FIG. 3). Furthermore, in the present embodiment, by executing the process in step S1014 in the above-described manner, an output unit and a second output unit are realized.

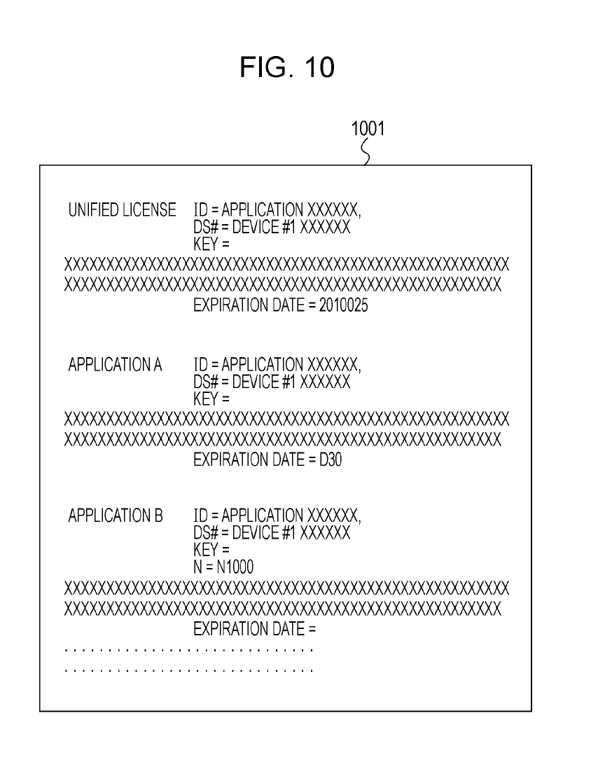

FIG. 10 illustrates an example of a format of the license file issued in step S1013 in FIG. 9.

In FIG. 10, the license file 1001 includes various kinds of control information in addition to the ID of each application whose operation is permitted by the license file 1001, or the device serial number of a device for which the operation is permitted. The license file 1001 also includes an encryption key by which to secure the license. When an application is added, if the configuration of the license is changed or a license is added, license information thereof is added to the license file 1001. Therefore, no influence occurs on the device operation based on the existence license file. One single unified license file can be issued from a plurality of license access numbers. By updating the license file, it is possible to control the operation of applications on the device.

In the example shown in FIG. 3, in a state in which applications A, B, and C have already been installed in the user system 102, an integrated package 304 is newly loaded. In this case, the installer of the integrated package 304 can determine that the information associated with the applications has been changed, by analyzing the license file 306 (the license file 1001 shown in FIG. 10) or the like transmitted from the license issuing server 101. This makes it possible to control installation of applications. In a case where license information of an existing application is changed to a license for a different version of application, it is possible to detect the change in a similar manner to the detection of license information for a new application.

In the present embodiment, as described above, in the state in which the user system 102 has applications A, B, and C which have already been installed, if the integrated package 304 is newly loaded, the user system 102 issues a request for the license file 306. More specifically, the user system 102 transmits the license access number LA#2 and the device serial number DS# uniquely assigned to the user system 102 to the license issuing server 101 thereby to request the license issuing server 101 to provide the license file 306.

According to the license access number LA#2 and the device serial number DS#, the license issuing server 101 determines whether any application in the integrated package 304 is identical to any application already installed in the user system 102. This determination is performed using information described in the license management database 106 that manages the information associated with individual applications included in the integrated package. In a case where it is determined that the integrated package 304 includes a duplicate application identical to an application which has already been installed, the license issuing server 101 re-configures the combination of applications in the integrated package to be installed. The re-configuration of the combination of applications in the integrated package to be installed is performed using the information described in the license management database 106. According to the result of the re-configuration, the license issuing server 101 produces a license file 306 including applications A, B, C, and α and a certificate 307 including license access numbers LA#3 for the duplicate applications A and C. The license issuing server 101 transmits the produced license file 306 and the certificate 307 to the user system 102.

This makes it possible to re-use the applications A and C which are duplicate with the already installed applications A, B, and C. For example, using the certificate 307 that permits the re-use of the applications A and C in the integrated package 304, a user is allowed to install the applications A and C of the integrated package 304 in an information processing apparatus different from the user system 102. This prevents the duplicate applications A and C from being wasted. Thus, improved convenience is provided to users. Conventionally, when a license is transferred, it is necessary to set a destination to which the license is transferred. In contrast, in the present embodiment, the certificate 307 including the license access number LA#3 for the duplicate applications A and C is provided, and thus it is not necessary to set a destination to which the license is transferred. Thus, it becomes possible to easily re-use the applications A and C which are duplicate with the already installed applications A, B, and C. In many cases, applications (for example, the applications B and α) included in the integrated package other than the re-usable applications A and B are installed as a set together with the applications A and C. In such a case, a user probably wants to purchase a license for applications (for example, the applications B and α) other than the re-usable applications A and B. In order to satisfy such a need, it is possible to sell a further license. This provides an advantage to the seller.

In the embodiment described above, it is assumed by way of example that the certificate 307 is an electronic certificate (an electronic file). However, the certificate does not necessary need to be formed in an electronic file. For example, paper on which the license access number LA# is printed may be used as the certificate. In this case, a user inputs the license access number LA# according to the number printed on the paper.

### Second Embodiment

Next, a second embodiment of the present invention is described below. In the following explanation, similar parts to those according to the first embodiment described above are denoted by similar reference numerals to those used in FIGS. 1 to 10, and a further detail explanation thereof is omitted.

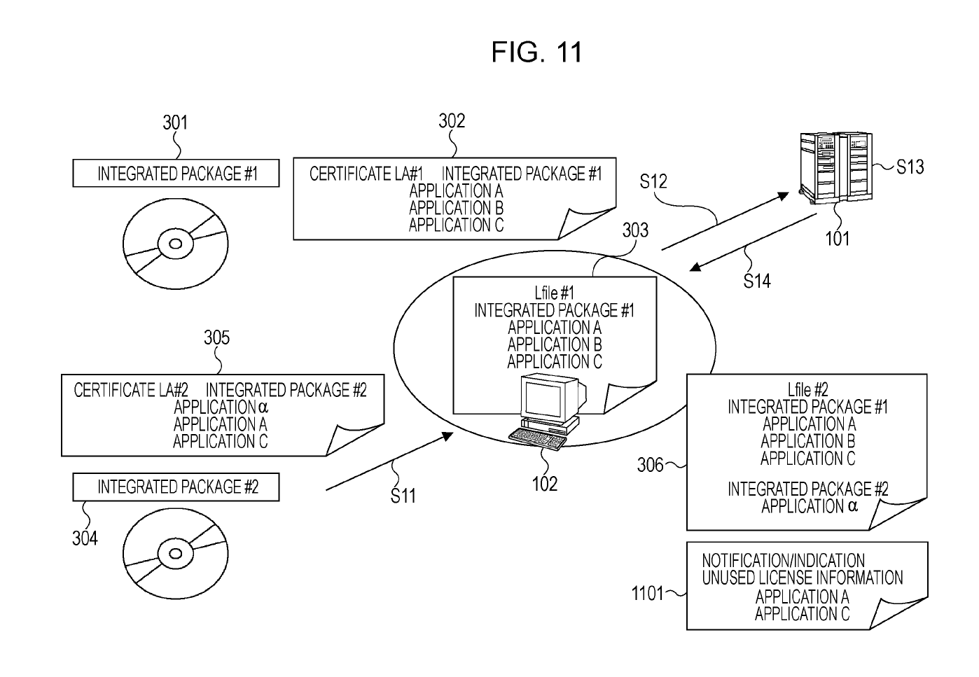

FIG. 11 is a diagram conceptually illustrating an example of a process of issuing a license file using a license management system.

In a user system 102 possessed by a user, an integrated package 301 and a license file (Lfie#1) 303 for an integrated package 301 are installed.

The installation thereof is performed using a license access number LA#1 described in a certificate 302 of the integrated package 301. In the integrated package 301 purchased by the user, three applications A, B, and C are packaged. By installing the integrated package 301 in the user system 102, it becomes possible for the user to use functions of the applications A, B, and C.

In the above-described situation, if the user performs an operation to install a new integrated package 304 including applications α, A, and C into the user system 102, using a license access number LA#2 described in a certificate 305 of the integrated package 304, then a process including steps S11 to S14 is performed as described below.

In step S11, if the integrated package 304 is loaded into the user system 102, the user system 102 requests a user to input a license access number LA#. The user inputs a license access number LA#2 described in the certificate 305 of the integrated package 304 by using the keyboard 204 of the user system 102.

In step S12, the installer of the integrated package 304 notifies the license issuing server 101 of the license access number LA#2 input in step S11 and a device serial number DS uniquely assigned to the user system 102. That is, the user system 102 requests the license issuing server 101 to provide a new license file 306.

In step S13, the license issuing server 101 receives the license access number LA#2 and the device serial number DS uniquely assigned to the user system 102 from the user system 102. The license issuing server 101 then searches for an already issued license file by using the received device serial number DS as a search key.

According to the received license access number LA#2 and the license file already issued, the license issuing server 101 determines whether any application in the integrated package 304 is identical to any application already installed in the user system 102. That is, the license issuing server 101 determines whether there is duplication between already installed applications and the applications included in the integrated package 304.

The license issuing server 101 issues the license access number LA#2 to permit re-use of a duplicate application which is included in the integrated package 304 and which is identical to an already installed application. The content of the license file (Lfile #2) 306 is a license that permits the operation of the applications A, B, and C in the integrated package 301 and the application α in the integrated package 304. In the present embodiment, this license file (Lfile #2) 306 overwritten on the license file (Lfile #1) 303 already installed in the user system 102. Note that original information associated with applications described in the license file (Lfile #1) 303 is retained even after the overwriting.

In step S14, the user system 102 receives the license file (Lfile #2) 306 and the application information 1101 that permits the re-use by the license access number LA#2. According to the license file (Lfile #2) 306, the user system 102 installs the application α which is one of applications A, C, and α included in the integrated package 304 and which is not duplicate with any of the already installed applications A, B, and C. The user system 102 then displays information on the display 201 (the display 121) to notify a user that the applications A and B are allowed to be installed for re-use by using the license access number LA#2.

More specifically, in this case, the process in step S410 shown in FIG. 4 is performed to make a determination not as to whether the certificate 307 including the license access number (LA#3) has been received but as to whether information indicating an application allowed to be re-used by the license access number LA#2. If it is determined that information indicating an application allowed to be re-used by the license access number LA#2 has been received, the process proceeds to step S411. In this case, instead of the display screen 601 shown in FIG. 6, a display screen is displayed which indicates that re-usable applications A and B are allowed to be further installed using the license access number LA#2.

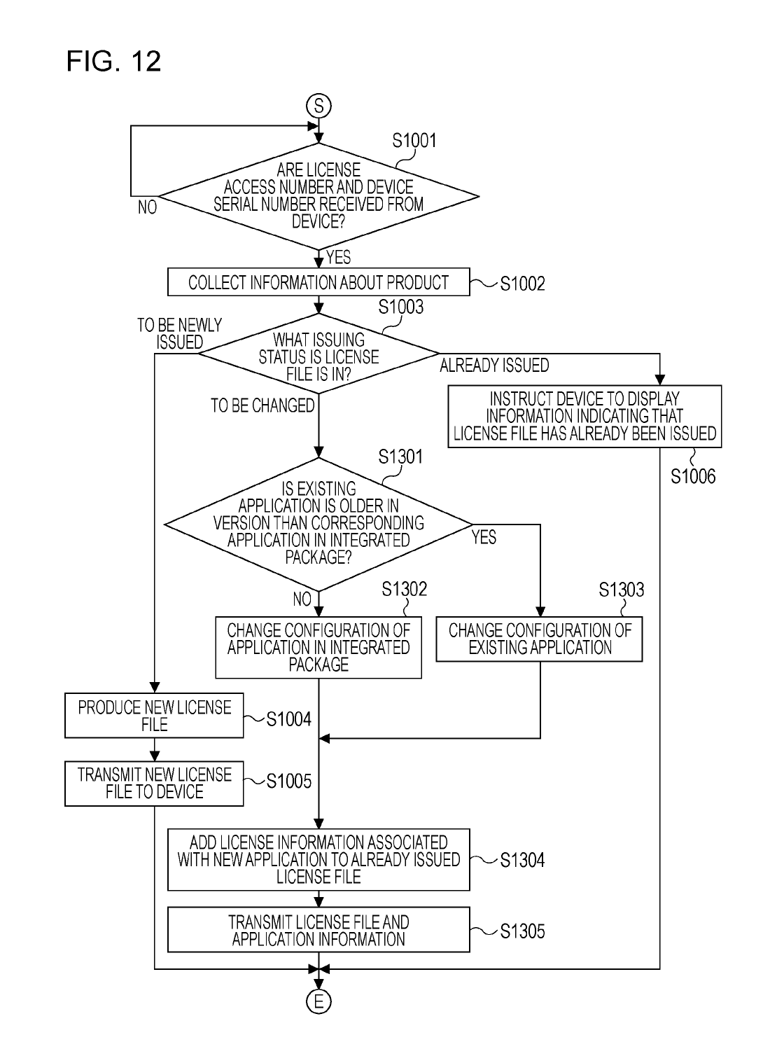

FIG. 12 is a flow chart illustrating an example of a process performed in the license issuing server 101 when a license file is issued. In FIG. 12, similar processing steps to those in the first embodiment are denoted by step numbers similar to those in FIG. 9, and the following explanation will focus on differences from the first embodiment.

In step S1301, the license issuing server 101 determines whether the version of the application already installed in the device is older than the version of the corresponding application included in the integrated package. If the result of the determination indicates that the version of the application already installed in the device is not older than the version of the corresponding application included in the integrated package, the process proceeds to step S1302. That is, in a case where the version of the application already installed in the device is the same as the version of the corresponding application included in the integrated package, the process proceeds to step S1302. In a case where the version of the application already installed in the device is newer than the version of the corresponding application included in the integrated package, the process also proceeds to step S1302.

In step S1302, the license issuing server 101 changes the configuration of applications included in the integrated package. More specifically, the license issuing server 101 produces information associated with the rearranged license management information table 830 from the license access number LA# bound to the device serial number DS# and the application ID. In this process, the license issuing server 101 describes, in the rearranged application ID 833, information associated with an application that is duplicate with an application already installed in the device and thus that is not used. Thereafter, the processing flow proceeds to step S1304 that will be described later.

On the other hand, in a case where the version of the application already installed in the device is older than the version of the corresponding application included in the integrated package, the processing flow proceeds to step S1303. In this case, the license issuing server 101 updates the license access number information table 740 associated with the old application to be updated (step S1303). More specifically, the license issuing server 101 updates the product code 743 to an ID of the new version. Furthermore, the license issuing server 101 updates the unified license file management number 748 to the number assigned to the license file of the integrated package bound to the transmitted license access number LA#. The license issuing server 101 then registers information associated with the old application in the standalone application table 840. Thereafter, the processing flow proceeds to step S1304.

In step S1304, the license issuing server 101 adds only the new applications to the already issued license file. Note that this process of adding the new applications includes rearrangement of the license to be updated. The license issuing server 101 relates the new applications to the following databases. That is, the license issuing server 101 relates the new applications to a license access number LA# or device serial number DS# described in the license file information table 770, the license access number information table 740, unified license management information table 810, etc., in the integrated product database 710.

In the present embodiment, by performing the process in steps S1301 to S1304 to change the registration information in the integrated product database 710, a changing unit is realized.

The license issuing server 101 transmits the new license file and the application information associated with the re-usable application to the device from which the license file acquisition request was received (step S1305). Thereafter, the process of the flow chart shown in FIG. 12 is ended.

In the present embodiment, as described above, the usage information that allows a user to use a duplicate application is realized by the application information (for example, the application information 1101 shown in FIG. 11) associated with a re-usable application. Furthermore, in the present embodiment, by executing the process in step S1305 in the above-described manner, an output unit is realized.

### Modifications

There can be various modifications to the first and second embodiments described above. For example, version information is compared between applications included in an integrated package to be newly installed and existing applications, and a license for an updated version of application may be issued.

The determination step S1007 or S1301 may additionally include a comparison in terms of one or both of the number of duplicate applications and the price (unit price) of an integrated package including a duplicate application. According to the result of the comparison as well as the result of the determination in step S1007 or S1301, a license file and a certificate are produced. This makes it possible to issue the license file and the certificate in various manners depending on the situation. That is, the license file and the certificate may be modified depending on the attribute information associated with the applications such as the number of applications included in the integrated package and/or the price (unit price) of the integrated package.

A duplicate application or a non-duplicate application may be allowed to be re-used under the restriction in terms of the period in which the application is allowed to be used and/or the function of the applications. In this case, for example, steps S1010 and S1011 may include an additional process of changing the configuration of the license management database 106 according to what is restricted or changing the content of the certificate. Note that the certificate issued in such a situation permits the application to be used in a shorter period or for a limited function compared with the original period or the original function.

A certificate for applications which are duplicate with already installed applications may be issued separately for each application or for a set of applications.

In the embodiments described above, the content of the certificate is displayed thereby to notify a user of the content of the certificate. Alternatively, the certificate may be converted into a document file (such as a pdf file) and saved, or the certificate may be printed by a printing apparatus thereby to notify a user of the content of the certificate. One or more functions of the user system 102 may be implemented on the printing apparatuses 123 to 125.

The license management system may include one information processing apparatus or may include a plurality of information processing apparatuses.

The scale of the license management system may be expanded while maintaining the configuration thereof.

### Other Embodiments

The units of the information processing apparatus and the steps of the application management method according to the above-described embodiments of the present invention can be realized by executing the program stored in a RAM or a ROM of a computer. Note that the program and a computer-readable storage medium in which the program is stored fall within the scope of the present invention.

The present invention may be implemented in the form of a system, an apparatus, a method, a program, a storage medium, etc. The present invention may be applied to a system including a plurality of apparatuses/devices, or may be applied to a single apparatus.

A software program that realizes a function of any embodiment of the present invention (for example, a program corresponding to the flow charts shown in FIG. 4, FIG. 9, or FIG. 12) may be supplied directly or indirectly or remotely to a system or an apparatus. The function of any embodiment of the present invention may be realized by a computer disposed in the system of the apparatus by reading the executing the supplied program code.

Thus, the program code installed on the computer to realize one or more functions according to any of the above-described embodiments of the invention on the computer also falls within the scope of the present invention. That is, the computer program for realizing one or more functions according to any of the above-described embodiments of the invention also falls within the scope of the present invention.

In this case, there is no particular restriction on the form of the program as long as it functions as a program. That is, the program may be realized in various forms such as an object code, a program executed by an interpreter, script data supplied to an operating system, etc.

Specific examples of storage media by which to supply the program include a floppy (registered trademark) disk, a hard disk, an optical disk, a magneto-optical disk, an MO disk, a CD-ROM disk, a CD-R disk, a CD-RW disk, etc. A magnetic tape, a non-volatile memory card, a ROM, a DVD (DVD-ROM, DVD-R) disk, or the like may also used as the storage medium for the above-described purpose.

The program may also be supplied such that a client computer may be connected to an Internet Web site via a browser, and an original computer program or a file including a compressed computer program and an automatic installer may be downloaded into a storage medium such as a hard disk of the client computer thereby supplying the program.

The program code of the program according to an embodiment of the present invention may be divided into a plurality of files, and respective files may be downloaded from different Web sites. Thus, a WWW server that provides, to a plurality of users, a program file that realizes one or more functions according to any embodiment of the invention on a computer also falls within the scope of the present invention.

The program according to the present invention may be stored in an encrypted form on a storage medium such as a CD-ROM and may be distributed to users. Particular authorized users are allowed to download key information used to decrypt the encrypted program from a Web site via the Internet. The decrypted program may be installed on a computer using the downloaded key information thereby achieving the one or more functions according to any embodiment of the present invention.

One or more functions according to any embodiment of the present invention may be realized by a computer by executing the program. Furthermore, one or more functions according to any embodiment of the present invention may be realized by an OS or the like running on a computer by executing part or all of a process.

A program may be read from a storage medium and loaded into a memory of a function extension board inserted in a computer or into a memory of a function extension unit connected to the computer, and a CPU or the like disposed in the function extension board or the function extension unit may perform part or all of the process according to the loaded program thereby achieving one or more functions according to any embodiment of the invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-188503 filed Jul. 19, 2007, which is hereby incorporated by reference herein in its entirety.

What is claimed is:

1. An information processing apparatus comprising:
a determination unit configured to determine whether at least one of a plurality of applications in integrated package software to be installed by inputting preset usage information is a duplicate application of an already installed application; and
an output unit configured to, when the determination unit determines that there is the duplicate application, output the usage information that allows a user to use the duplicate application.

2. The information processing apparatus according to claim 1, further comprising:
a reconfiguration unit configured to, when the determination unit determines that there is the duplicate application, reconfigure a combination of applications in the integrated package software to be installed, in accordance with a result of the determination.

3. The information processing apparatus according to claim 2, further comprising:
a second output unit configured to output license information associated with applications reconfigured by the reconfiguration unit.

4. The information processing apparatus according to claim 2, further comprising:
a comparison unit configured to, when the determination unit determines that there is duplication between applications, compare attribute information between duplicate applications,
wherein the reconfiguration unit reconfigures the combination of applications in the integrated package software to be installed, according to a result of the determination performed by the determination unit and a result of the comparison performed by the comparison unit.

5. The information processing apparatus according to claim 4, wherein the attribute information includes at least one of information indicating a version of the application; information indicating a unit price of the integrated package; and information indicating a number of applications included in the integrated package.

6. The information processing apparatus according to claim 1, further comprising:
a receiving unit configured to receive license issue request information indicating a request for issuing a license of integrated package software from an external information processing apparatus into which the integrated package software is to be installed,
wherein the determination unit determines whether there is duplication between applications in the integrated package software already installed in the external information processing apparatus, on the one hand, and applications in the integrated package software the license for which is requested by the license issue request information, on the other hand, and
wherein if the determination unit determines that there is a duplicate application, the output unit transmits the usage information that allows a user to use the duplicate application to the external information processing apparatus.

7. The information processing apparatus according to claim 6, wherein the receiving unit receives, as the license issue request information, identification information identifying the external information processing apparatus and certificate information associated with a certificate of the integrated package software to be installed,
wherein the information processing apparatus further comprises:
a first identifying unit configured to identify each application already installed in the external information processing apparatus, from information managed by a database, in accordance with the identification information received by the receiving unit; and
a second identifying unit configured to identify each application included in the integrated package software to be installed, from information managed by a database, in accordance with the certificate information received by the receiving unit, and
wherein the determination unit determines, in accordance with results of the identification performed by the first identifying unit and the second identifying unit, whether there is duplication between applications in the integrated package software to be installed in the external information processing apparatus, on the one hand, and applications in integrated package software already installed in the external information processing apparatus, on the other hand.

8. The information processing apparatus according to claim 1, wherein the output unit outputs, as the usage information, information associated with a certificate of the duplicate application.

9. The information processing apparatus according to claim 1, wherein the output unit outputs certificate information associated with a certificate of the integrated package software including the duplicate application.

10. The information processing apparatus according to claim 1, wherein the output unit outputs certificate information associated with a certificate that restrictively defines at least one of a period in which the duplicate application is valid; and a function of the duplication application.

11. The information processing apparatus according to claim 1, further comprising:
a changing unit configured to, when the determination unit determines that there is the duplicate application, change registration information described in a database that manages use of the applications in the integrated package software so that use of the duplicate application is permitted,
wherein the output unit outputs, after the registration information described in the database is changed by the changing unit, the usage information indicating that the duplicate application is permitted to be used.

12. An application management method comprising:
determining whether at least one of a plurality of applications in integrated package software to be installed by inputting preset usage information is a duplicate application of an already installed application; and
outputting, when it is determined in the determining that there is the duplicate application, the usage information that allows a user to use the duplicate application.

13. The application management method according to claim 12, further comprising:
reconfiguring, when it is determined in the determining that there is the duplicate application, a combination of applications in the integrated package software to be installed, in accordance with a result of the determination.

14. The application management method according to claim 13, further comprising:
outputting license information associated with applications reconfigured in the reconfiguring.

15. The application management method according to claim 13, further comprising:
comparing, when it is determined in the determining that there is duplication between applications, attribute information between duplicate applications,
wherein the reconfiguring includes reconfiguring the combination of applications in the integrated package software to be installed, according to a result of the determination performed in the determining and a result of the comparison performed in the comparing.

16. The application management method according to claim 15, wherein the attribute information includes at least one of information indicating a version of the application; information indicating a unit price of the integrated package; and information indicating a number of applications included in the integrated package.

17. The application management method according to claim 12, further comprising:
receiving license issue request information indicating a request for issuing a license of integrated package software from an external information processing apparatus into which the integrated package software is to be installed,
wherein the determining includes determining whether there is duplication between applications in the integrated package software already installed in the external information processing apparatus, on the one hand, and applications in the integrated package software the license for which is requested by the license issue request information, on the other hand, and
wherein the outputting usage information includes, if it is determined in the determining that there is a duplicate application, transmitting the usage information that allows a user to use the duplicate application to the external information processing apparatus.

18. The application management method according to claim 17, wherein the receiving includes receiving, as the license issue request information, identification information identifying the external information processing apparatus and certificate information associated with a certificate of the integrated package software to be installed,
wherein the method further comprises:
identifying each application already installed in the external information processing apparatus, from information managed by a database, in accordance with the identification information received in the receiving; and
identifying each application included in the integrated package software to be installed, from information managed by a database, in accordance with the certificate information received in the receiving,
wherein the determining includes determining, in accordance with results of the identification performed in the identifying the each already-installed-application and the identifying the each to-be-installed application, whether there is duplication between applications in the integrated package software to be installed in the external information processing apparatus, on the one hand, and applications in integrated package software already installed in the external information processing apparatus, on the other hand.

19. The application management method according to claim 12, wherein the outputting includes outputting, as the usage information, information associated with a certificate of the duplicate application.

20. The application management method according to claim 12, wherein the outputting includes outputting certificate information associated with a certificate of the integrated package software including the duplicate application.

21. The application management method according to claim 12, wherein the outputting includes outputting certificate information associated with a certificate that restrictively defines at least one of a period in which the duplicate application is valid; and a function of the duplication application.

22. The application management method according to claim 12, further comprising:
changing, when it is determined in the determining that there is the duplicate application, registration information described in a database that manages use of the applications in the integrated package software so that use of the duplicate application is permitted,
wherein the outputting includes outputting, after the registration information described in the database is changed in the changing, the usage information indicating that the duplicate application is permitted to be used.

23. The application management method according to claim 12, further comprising:
installing integrated package software including a plurality of different applications;
transmitting license issue request information indicating a request for issuing a license of integrated package software to be installed in the installing, to a server;
receiving license information indicating the license transmitted from the server in accordance with the license issue request information transmitted in the transmitting;
determining, on the basis of the license information received in the receiving, whether there is duplication between already installed applications on the one hand and applications in the integrated package software to be installed on the other hand; and
uninstalling, of the already installed applications, a duplicate application detected in the determining whether there is the duplication between the already installed applications on the one hand and the applications in the integrated package software to be installed on the other hand,
wherein the installing includes reinstalling the duplicate application detected in the determining, after the application is uninstalled in the uninstalling.

24. A computer-readable storage medium storing a program adapted to make a computer execute the application management method according to claim 12.
